(19) United States
(12) Patent Application Publication
(10) Pub. No.: US 2007/0060397 A1
(43) Pub. Date: Mar. 15, 2007

(54) W-shaped arms for hookes-type universal joint

(75) Inventors: Robert J. Ostrander, Orchard Lake, MI (US); Christopher Steele, Lake Orion, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/223,427

(22) Filed: Sep. 9, 2005

(51) Int. Cl. F16D 3/16

(52) U.S. Cl. 464/134

(57) ABSTRACT

A Hookes-type universal joint is provided with a yoke having outwardly facing surfaces on arms that are generally W-shaped in cross section. A central rib is part of the W-shape and provides a more rigid structure that allows a good deal of material to be removed between the central rib and two outer ribs. The area between the central rib and the two outer ribs is cut away in a curve to remove additional material. The present invention thus provides a very low weight universal joint.

### BACKGROUND OF THE INVENTION

This invention relates to an improved yoke for a universal joint, wherein side arms of the yoke have a W-shaped cross section that results in a much lighter weight yoke.

As known, universal joints are utilized to transmit rotation between a drive shaft and a driven shaft. The universal joint allows the angle of the two shafts to vary, while rotation is still transmitted. In a Hookes-type universal joint, a yoke is attached to an end of each of the shafts. The yokes are mounted on a cross member, with the cross member having a pair of arms received in openings in each of the two yokes.

A good deal of design effort has been made with regard to the structure and shape of the yokes. Originally, the side arms of the yokes were relatively flat planar structures. In a step away from the essentially flat structure, one prior art universal joint utilized a C-shaped cross section. One benefit of the C-shaped cross section was the elimination of a good deal of material from the yokes.

However, while the C-shaped cross section provides the benefit of reduced weight, the C-shaped cross section does not optimize the amount of material that can be removed without adversely affecting stress concentration areas in the yoke. Thus, a design that would allow more material to be removed from the yoke without compromising strength is desirable.

### SUMMARY OF THE INVENTION

In a disclosed embodiment of this invention, a yoke for a universal joint has two spaced-apart arms that are formed of a forged or cast material. A cross section of these two spaced-apart arms has a central rib positioned between two outer ribs to form a generally W-shape. A good deal of material can be removed from between the central rib and each of the outer ribs. This provides a very low weight yoke. The central rib adds additional strength to the cross section, allowing the additional material to be removed.

In the disclosed embodiments, the central rib extends away from an outer wall for approximately the same height as the outer ribs. Further, there are curved surfaces between the central rib and the outer ribs.

These and other features of the present invention can be best understood from the following specification and drawings, the following of which is a brief description.

### BRIEF DESCRIPTION OF THE DRAWINGS

FIG. 1 shows a prior art universal joint coupling.

FIG. 2 shows a yoke portion according to the present invention.

FIG. 3 is a cross-sectional view along line 3-3 as shown in FIG. 2.

### DETAILED DESCRIPTION OF THE PREFERRED EMBODIMENT

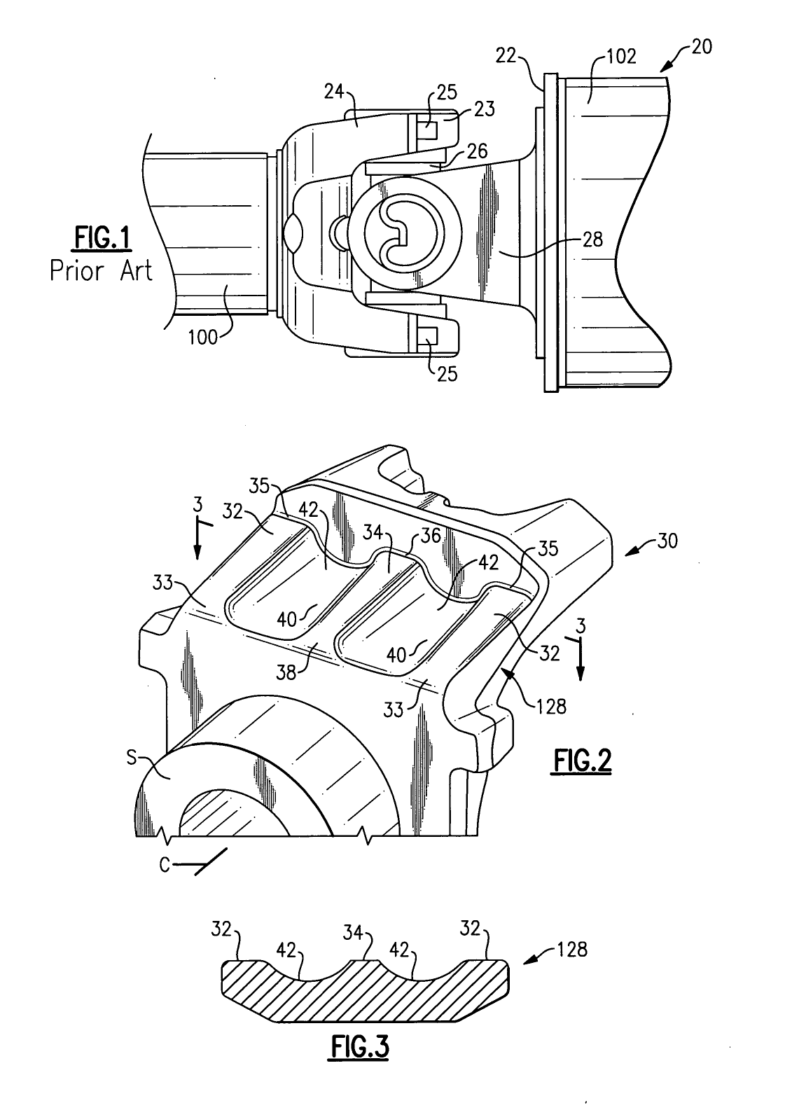

A universal joint 20 is illustrated in FIG. 1. As known, a first yoke member 22 is connected to a second yoke member 24 by each surrounding two opposed arms on a cross member 26. The first and second yoke members 22 and 24 are connected to shafts 100 and 102. As is known, one of the shafts 102 and 100 is a drive shaft and the other is driven. The universal joint 20 allows an angle between the two shafts to vary, while rotation is still transmitted. As shown, an arm has an outer facing surface 28 that is generally planar. As mentioned above, in one prior art structure, this surface 28 has been made to have a C-shaped cross-section.

As can be seen in FIG. 1, a band 23 is bolted at 25 to the second yoke member 24. There are generally two types of yokes, with one type having a “full round” opening to receive cross member arms, and the other type having a band such as band 23. While the inventive yoke is shown in FIG. 2 as the type having a band, it should be appreciated that the present invention extends to either type yoke.

A universal joint yoke 30 is illustrated in FIG. 2 having two opposed side arms 128 (only one is shown) with outer ribs 32, and a central rib 34. As is shown, the central rib 34 extends upwardly away from a central axis C of the yoke 30 for a distance that decreases from a forward end 36 and towards a shaft end 38. That is, the rib 34 decreases in height moving away from the connection to the cross member. Similarly, the outer ribs 32 decrease in height from a forward end 35 towards a rear end 33.

The area 42 between the outer ribs 32 and the central rib 34 has a scalloped or curved cut-out shape 40. As can be appreciated from FIG. 2, there is a good deal more material removed due to the scalloped cut-out areas 40 compared to the prior art. The central rib 34 provides strengthening allowing this removal of material.

FIG. 3 shows that the scalloped cut-out areas 40 are curved. Notably, the outer ribs 32 and the central rib 34 all extend for an approximately equal height at any point taken along the length.

The present invention has been disclosed in a preferred embodiment. However, a worker of ordinary skill in the art would recognize that certain modifications would come within the scope of this invention. For that reason, the following claims should be studied to determine the true scope and content of this invention.

What is claimed is:

1. A universal joint comprising:
a pair of yokes, said pair of yokes being attached to a cross member, each of said pair of yokes having a pair of opposed arms, and a central axis, said pair of opposed arms each having a surface facing outwardly away from said central axis, with said surface having a generally W-shaped cross section.

2. The universal joint as set forth in claim 1, wherein said W-shaped cross section is defined by a pair of outer ribs, and a central rib.

3. The universal joint as set forth in claim 2, wherein said central rib and said pair of outer ribs extend outwardly away from a plane receiving said central axis by an approximately equal amount.

4. The universal joint as set forth in claim 2, wherein said central rib and said pair of outer ribs decrease in height from a forward portion adjacent to said cross member to a rearward portion in a direction moving away from said cross member.

5. The universal joint as set forth in claim 2, wherein a cut-out area is provided between said central rib and each of said pair of outer ribs.

6. The universal joint as set forth in claim 5, wherein said cut-out area includes a curved cross-section for at least a portion of said surface.

7. A yoke for a universal joint comprising:
a yoke having a pair of opposed arms, and a central axis, said pair of opposed arms each having a surface facing outwardly away from said central axis, with said surface having a generally W-shaped cross section.

8. The yoke as set forth in claim 7, wherein said W-shaped cross section is defined by a pair of outer ribs, and a central rib.

9. The yoke as set forth in claim 8, wherein said central rib and said pair of outer ribs extend outwardly away from a plane receiving said central axis by an approximately equal amount.

10. The yoke as set forth in claim 8, wherein said central rib and said pair of outer ribs decrease in a height from a forward portion adjacent to an opening that will receive a cross member, to a rearward portion in a direction moving away from said opening.

11. The yoke as set forth in claim 8, wherein a cut-out area is provided between said central rib and each of said pair of outer ribs.

12. The yoke as set forth in claim 11, wherein said cut-out area includes a curved cross-section for at least a portion of said surface.
